(19) United States
(12) Patent Application Publication
(10) Pub. No.: US 2025/0111143 A1
(43) Pub. Date: Apr. 3, 2025

(54) COMPUTER IMPLEMENTED METHOD AND SYSTEM

(71) Applicant: BUBBLR INC., London (GB)

(72) Inventor: Stephen MORRIS, Keltybridge (GB)

(21) Appl. No.: 18/376,101

(22) Filed: Oct. 3, 2023

(51) Int. Cl. G06F 40/20; G06F 16/432

(52) U.S. Cl. CPC G06F 40/20; G06F 16/433; G06F 16/434

(57) ABSTRACT

The present disclosure relates to generating responses to queries which may be provided to a large language model. The present disclosure addresses the problem of a lack of contemporaneity in large language models.

### FIELD

The invention relates to a method and system. Particularly, but not exclusively, the invention relates to a method and system for providing a response to a query from a client.

### BACKGROUND

The world has now started to avail itself of the merits of generative artificial intelligence, using it to generate content and receive responses in a more natural, conversational format.

One of the problems with generative artificial intelligence is the limitation on its training data, which means the responses can sometimes be incorrect when it comes to queries which have an element relating to current or dynamic data.

Aspects and embodiments were conceived with the foregoing in mind.

### SUMMARY

Viewed from a first aspect, there may be provided a computer-implemented method of providing a response to a query from a client device. The client device may comprise any computing device. The method may be implemented by a processing resource. Such a processing resource may be any computing resource which can provide processing capacity. The processing resource may be hardware or software implemented. The processing resource may be implemented in the cloud or across a distributed computer.

The method may comprise providing a platform configured to receive a query from a client device. The platform may be implemented using software or hardware or through the cloud. The platform may be accessed by the client device using any suitable means such as, for example, an application programming interface (API). A query may be any phrase comprising at least one statement comprising alphanumeric characters. A query may also comprise image or audio visual components.

The method may comprise receiving the query from a client device via a user interface. The query may be provided through an API and/or it may be transmitted to the processing resource and/or platform using any suitable telecommunications means or protocol. The user interface may comprise suitably arranged input regions to enable the query to be provided.

The method may comprise processing the query to generate a prompt for a large language model (LLM). A prompt for a large language model may be generated based on the prompt through the application of natural language processing or artificial intelligence.

The method may comprise determining, using the prompt, whether the query relates to contemporaneous data. A determination of whether the prompt relates to contemporaneous data may be understood to be an analysis of the data to determine whether it relates to dynamic content. This may be by reference to a point in time, such as a training date of the large language model, or to the likelihood that the prompt relates to dynamic content, i.e., if it relates to a quantity which can change in time.

The method may comprise, based on the determination, providing a response including a contemporaneous component. The response may be provided using any suitable means such as, for example, a messaging application, email or a notification on a client device.

Large language models may be understood as deep learning algorithms which utilise transformer models which are trained using large datasets. This enables them to generate content of their own, such as a response to a prompt. Large language models may pertain to a specific technical context, such as, for example, a specific commercial or technical sector. Examples may be large language models trained on chemical data, environmental data or technical data relating to a specific technical field.

A method in accordance with the first aspect enables large language models to be used to provide contemporaneous content in response to queries. The contemporaneous content may well be used to update the training of the large language model.

A determination may be made whether the query relates to a contemporaneous component. A further determination may then be made as to whether the large language model can provide the contemporaneous component and, if the large language model cannot provide the contemporaneous component, a search engine may be accessed to obtain the contemporaneous component.

Optionally, providing a response including a contemporaneous component may comprise: if the query relates to contemporaneous data, determining whether the large language model is configured to provide a contemporaneous component; and if the large language model is configured to provide a contemporaneous component, providing a response based on output from the large language model, wherein the response comprises the contemporaneous component; and if the large language model is not configured to provide a contemporaneous component, obtaining the contemporaneous component and providing a response including the obtained contemporaneous component.

That is to say, the effect of this feature is that the response is provided based on whether the large language model can provide the contemporaneous component, i.e. is it likely the large language model has up to date data. If it is not likely the large language model can provide the contemporaneous content then the claimed method can retrieve the up to date data and use it in the response to the query. This improves the query responses which can be provided by large language models.

Processing the query to generate a prompt for a large language model comprises the application of natural language processing or machine learning techniques to determine the prompt for the large language model.

Processing the query to generate a prompt may comprise the use of a trained model.

A trained model may be implemented using the application of an artificial neural network (ANN) or a convolutional neural network (CNN), which is trained as set out above. ANNs can be hardware—(neurons are represented by physical components) or software-based (computer models) and can use a variety of topologies and learning algorithms. ANNs usually have at least three layers that are interconnected. The first layer consists of input neurons. Those neurons send data on to the second layer, referred to a hidden layer which implements a function and which in turn sends the output neurons to the third layer. There may be a plurality of hidden layers in the ANN. With respect to the number of neurons in the input layer, this parameter is based on training data.

The second or hidden layer in a neural network implements one or more functions. For example, the function or functions may each compute a linear transformation or a classification of the previous layer or compute logical functions. For instance, considering that the input vector can be represented as x, the hidden layer functions as h and the output as y, then the ANN may be understood as implementing a function fusing the second or hidden layer that maps from x to h and another function g that maps from h toy. So the hidden layer's activation is f(x) and the output of the network is g(f(x)).

Such a trained model may also deploy convolutional neural networks (CNNs). CNNs can also be hardware or software based and can also use a variety of topologies and learning algorithms. A CNN usually comprises at least one convolutional layer where a feature map is generated by the application of a kernel matrix to an input image. This is followed by at least one pooling layer and a fully connected layer, which deploys a multilayer perceptron which comprises at least an input layer, at least one hidden layer and an output layer. The at least one hidden layer applies weights to the output of the pooling layer to determine an output prediction.

The training of the trained model may be implemented using any suitable approach such as, for example, supervised, semi-supervised or unsupervised learning. It may be trained on a syntax describing the rules and/or structures for a prompt of a large language model.

Optionally, the determination of whether the query relates to contemporaneous data may comprise providing a prompt to a large language model, wherein providing the prompt may utilises a low randomness request, e.g., zero-temperature request to ChatGPT.

The effect of this is that the determination of contemporaneity of the query is quick and easy to process as it returns a yes or no answer from the large language model.

A trained model which deploys an ANN and/or a CNN may also be utilised in the determination of whether the query relates to contemporaneous data. The trained model may be trained to recognise terms which indicate a dynamic aspect of the query, such as, for example, a reference to time (e.g., the word current) or a reference to an identity (i.e., the word “Who”). That is to say, the trained model is trained to determine the presence of terms which identify contemporaneity, i.e. the quality of being current, in the query. Alternatively, the trained model may be trained on specific terms which indicate a dynamic quantity is involved.

Providing the response including the contemporaneous component may comprise: updating the large language model to include the contemporaneous component; obtaining a response from the large language model including the contemporaneous component.

That is to say, the contemporaneous data which is obtained using the claimed method may be used to update the large language model. Further contemporaneity checks may be undertaken on the contemporaneous data to see if it itself contains contemporaneous components. Optionally, the method may further comprise obtaining a further response component and determining whether the further response component comprises further contemporaneous components. The technical effect of this is that the response is processed to determine whether it has aspects which could be dynamic and need updating. The update may be based on a randomness setting provided by the large language model. For instance, a low randomness, i.e., zero temperature in ChatGPT, may mean that further response components are not needed as what has already been provided is fact-based and not subjective in content.

Prior to providing the response including the contemporaneous component, a validation process is applied to the response. Any suitable validation technique may be utilised here. The effect of this is that a message can be added to the response to provide a likelihood that the data represents the truth. This may also be based on a randomness setting utilised by the large language model. Low randomness settings are less likely to lead to subjective content being provided by the large language model. That is to say, for example, the validation process may be based on a temperature setting in the large language model.

Optionally, the query may comprise an image component, wherein the query may be pre-processed to extract content from the image. The pre-processing may comprise the application of at least one CNN to the image.

Optionally, the query may also comprise an audio component, wherein the query may be pre-processed to extract content from the audio component utilising digital signal processing techniques.

Either or both of the prompt and query may be re-processed and/or regenerated to provide an updated response to the query. The updated response may be provided responsive to new information being provided as part of a revised query. The re-processing and/or re-generation of the prompt and/or query may be responsive to user input via a user interface at the client. The user input may express dissatisfaction with the initially generated response. The user interface may be used to provide the initial response, receive the user input and provide the revised response using a chatbot interface.

The reprocessing and/or regeneration may utilise a second large language model which may be distinct from the first language model. The re-processing and/or regeneration may adjust the parameters of the query.

Systems, non-transitory computer readable mediums and computing devices may each be configured to implement any aspect of the method set out in the first aspect.

### BRIEF DESCRIPTION OF THE DRAWING FIGURES

An embodiment will now be described by way of example only and with reference to the following drawings in which:

FIG. 1 illustrates the flow of data between the components of a system configured in accordance with an embodiment; and

FIG. 2 illustrates a flow diagram describing a method of providing a response to query in accordance with an embodiment.

### DESCRIPTION

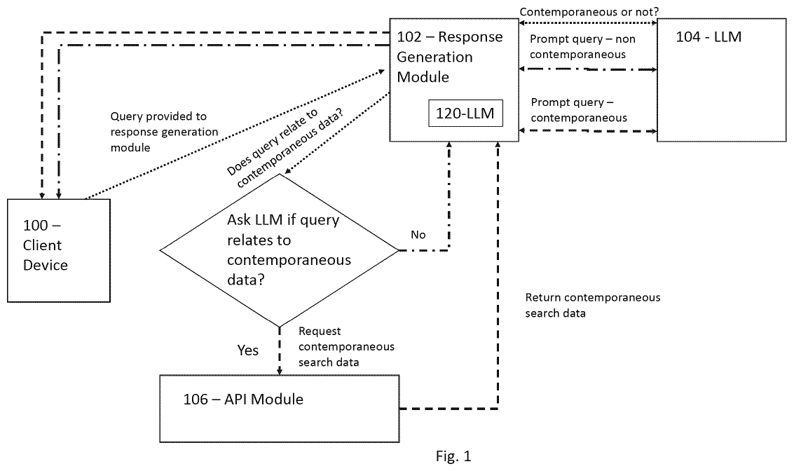

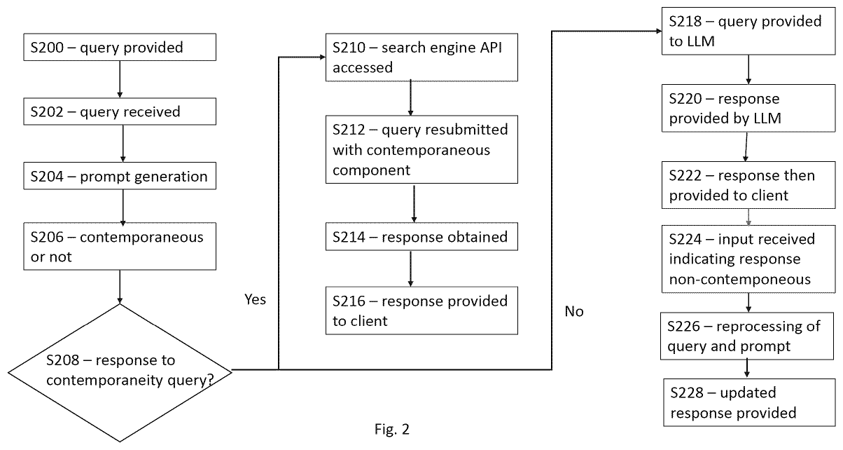

We now describe, with relation to FIGS. 1 and 2, a system and the flow of data between the components of that system in order to implement an embodiment.

In a step S200, client device 100 provides a query to response generation module 102. The communication between client device 100 and response generation module 102 may be implemented using any suitable data communication protocol. The response generation module 102 implements a platform which generates responses to queries provided by client devices, such as client device 100.

Client device 100 may be any computing device which is configured to connect to the response generation module 102, Configuring the client device 100 to connect to the response generation module 102 may be enabled using suitable computer program instructions. The response generation module 102 may be configured to access a profile associated with the client device 100 and may store details associated with a user of the client device 100. The response generation module 102 may be configured to apply anonymisation techniques to personal data associated with the user of the client device 100 when they are stored on or needed by the response generation module 102.

Communications between the client device 100 and the response generation module 102 may also be implemented using an application programming interface (API) which provides access to the response generation module 102 through a suitably configured user interface.

In a step S202, the response generation module 102 receives the query from the client device 100 and, in a step S204, the response generation module 102 is configured to utilise natural language processing routines to generate a prompt which is suitable for a large language model 104. An example large language model is ChatGPT but other large language models may also be used. The response generation module 102 may also be configured, alternatively or additionally, to utilise machine learning approaches which are trained on the prompt generation rules of a particular large language model.

On obtaining the prompt, in a step S206, the response generation module 102 may be configured to determine whether the prompt relates to contemporaneous data, which will provide a direct indication of whether the source query provided in step S200 relates to contemporaneous data. This may involve the application of a trained model which applies a neural network to the prompt to determine the content of the prompt relate to contemporaneous data. This may be by training the neural network to identify words or phrases in the query which indicate that a contemporaneous element is present in the prompt such as, for example, “When”, “Who”, “How many” etc or even just the presence of prompt components which indicate a dynamic entity is concerned such as, for example, a current monarch, an environmental condition or a stock price.

Alternatively or additionally, the response generation module 102 may provide a request to a large language model 104 to ask whether the prompt relates to contemporaneous data. Using ChatGPT as an example of the LLM, this may be implemented using a prompt which directly requests whether the query relates to contemporaneous data. This request may utilise a zero-temperature setting within ChatGPT which asks for a purely deterministic yes/no answer. LLM 104 may also be a private LLM.

Whilst large language models are used here in the general context, the claimed method may also be deployed in relation to a large language model 104 which has a more specific context. That is, one which is trained on a specific technical or commercial sector and so provides responses which are relevant to that sector.

By determining whether the prompt relates to contemporaneous data, it can be directly inferred whether the query relates to contemporaneous data. That is to say, if it can be determined using the LLM 104 that the prompt relates to contemporaneous data a yes can be returned to the response generation module 102 and if it can be determined that the prompt relates to non-contemporaneous data a no can be returned. In other words, as the prompt is generated based on the query, the prompt being related to contemporaneous data indicates that the query relates to contemporaneous data.

In a step S208, the response generation module 102 obtains the result of the determination of whether the query relates to contemporaneous data. That is to say, a yes or no answer indicating contemporaneity of the query provided in step S200.

If it is determined that the query does relate to contemporaneous data then an API module 106 is activated to enable a search engine API to be accessed. This is step S210. Examples of such a search engine API are the Google Custom Search API and the Microsoft Bing Web Search API but other search APIs may be used. The respective API is then used to provide a search for the contemporaneous data to which the query relates. Prior to step S210, a further processing step may be implemented which uses the training date of the large language model 104 to determine whether, even if the query does relate to contemporaneous data, the large language model 104 is likely to have the correct data as the training date is more recent than the change to the relevant data is likely to have been.

For example, if the query asks “Who is the current Monarch in the UK?” (which would evidently be determined as contemporaneous as it relates to a situation which has changed since September 2022 and ChatGPT is only up-to-date until September 2021) then this would be provided to the search engine API.

On obtaining the results, in a step S212, the response generation module 102 resubmits the query to the LLM 104 with the data returned from the request provided to the search APIs in step S210. This can be implemented through uploading the returned data which has been obtained as a result of using the search APIs. The upload can be implemented using, for example, the ChatGPT API which can receive a document (containing the contemporaneous search results) as an upload and then receive prompts which can be based on the document. That is to say, the response generation module 102 can generate a document which contains the data returned from the request in step S210 and then provide a new prompt based on the uploaded document, i.e., the contemporaneous data.

A response can then be obtained from the large language model 104 which includes the contemporaneous component provided by the search query. This is step S214. That is to say, a query which initially asks “Who is the Monarch in the UK?” can, using the claimed method, return the result “The current monarch in the UK is King Charles III, who ascended to the throne after his mother, Queen Elizabeth II, died in September 2022” rather than the incorrect result “The current Monarch in the UK is Queen Elizabeth II”, which would be returned by ChatGPT without the claimed method.

Such a response can be altered based on the temperature settings associated with the corresponding user. For instance, the response “The current monarch in the UK is King Charles III, who ascended to the throne after his mother, Queen Elizabeth II, died in September 2022” would be associated with a low temperature setting of around 0.3 in ChatGPT. If the user altered their temperature setting (to between 0.5 and 0.7) then a more creative response may be provided by ChatGPT and it may something like ““The current monarch in the UK is King Charles III, who ascended to the throne after his mother, Queen Elizabeth II, died of old age in September 2022. The crowning of King Charles III led to discussions about whether New Zealand, where King Charles III is also head of state, could now pursue their objective of becoming a republic”. That is to say, the alteration of the temperature setting (which characterises the randomness in the response) could lead to other responses being generated with more subjective content added. This would mean that queries entered into the client device would yield more creative responses which, yet still, include the contemporaneous component which is desired from such a query.

On obtaining the result from the large language model 104 which includes the contemporaneous component, a response can then be provided by the response generation module 102 to the client device. This is step S216. The response can be provided by any suitable means, i.e., messaging service, notification, email or directly through a user interface.

If, in step S208, the prompt to the large language model 104 returns an answer of no, i.e., the query does not relate to contemporaneous data, then a separate set of actions can be taken.

In a step S218, the large language model 104 is provided with the query with a request for results. This is on the basis that non-contemporaneous data should not impact on the results which are obtained from a large language model 104 as the data is non-contemporaneous. A query which does not relate to contemporaneous data could be something like “Is 1 a prime number?” and this, on being put in prompt form to a large language model 104 such as ChatGPT, would return an answer something like “No, 1 is not a prime number. The smallest prime number is 2”. This is step S220.

The response can then be provided to the client in step S222. The response, including the contemporaneous component, may be provided on the client device 100 by way of a suitably configured user interface. Other communication means may be utilised to provide the response. For example, the response may be provided by notification on the client device 100. In other examples, the response may be provided using email or a messaging service.

The client device, upon showing the provided response, may then receive an input from the user at the client indicating dissatisfaction with the response. This may be because, the response is not what the user expected. This may be responsive to a selection of a link which asks the user whether they are satisfied with the response to their query. The link may be provide via a suitable user interface. The link, may, for example, ask if the response was up-to-date or what would be expected.

In the example discussed above, this may be because the output from step S208 in response to the query “Who is the current monarch in the UK?” was determined to be non-contemporaneous, i.e. provide a no instead of a yes at the determination of contemporaneity in step S208. This may be because, for instance, the LLM 104 has a very recent training date regarding this data which indicates the data is likely to be up-to-date, i.e. returning a response to a query indicating non-contemporaneity because the data is likely to be up-to-date even if it is not, i.e. in the case of a recent sudden death of the current monarch. It may also be, because, the query was actually “Who is the monarch in the UK” and so the word “current”, i.e. a strong indicator of contemporaneity, was not detected at the query processing and prompt generation stage in step S204 because it was, in fact, omitted from the query.

That is to say, the pathway of steps S218 to S222 were followed even though it should not have been and it has returned a response which is incorrect or at least unsatisfactory. An example response could be “The current monarch in the UK is King Charles III” even if King Charles III had very recently passed away. The input indicating that the response is not contemporaneous, i.e. indicative of current events, is received by the response generation module 102 in step S224.

The response generation module 102 may then re-process the query provided in step S200 and provide a re-generated prompt to an additional LLM 120 which may be hosted by the response generation module 102. The LLM 120 may be a private LLM which is hosted by the response generation module 102. The LLM 120 may be located remotely relative to the response generation module 102. Such an additional LLM 120 may be implemented, for example, using Private GPT.

The re-processing and re-generation of the prompt may add the requirement for the answer to be current, i.e. provide an explicit request for contemporaneity. The re-processing may also increase or decrease a default randomness setting. This is step S226.

The additional LLM 120 may be trained on the query and response pairs which have been provided by the response generation module 102 previously. That is to say, where a query has been made and provided a satisfactory response in step S222 (or step S216), this may be used to label a response to a query in the training of the LLM 120. Similarly, the unsatisfactory responses may also be used to train the LLM 120. The LLM 120 could additionally be trained based on news sources to enable it to pick up very recent events. The LLM 120 could be a private LLM which is controlled by the operator of response generation module 102.

The satisfactory/unsatisfactory responses may also be used to train a policy function in accordance with the principles of reinforcement learning. This may be to train an additional neural network implemented by the response generation module 102 to provide responses to questions which may not need the LLM 120.

An updated response may then be generated by LLM 120 and provided by the response generation module 102 to the client device 102 in a step S228. The updated response may read “King Charles III has recently died. It is expected that his son, Prince William, will take the throne and be the new monarch in the UK.”. Steps S224 to S228 may be repeated until a satisfactory answer has been indicated at the client device 102.

Alternatively or additionally, the query provided in step S200 may comprise an audio or an image component. A query comprising an audio component may be pre-processed using digital signal processing techniques to identify its content. The identified content may then be provided with the query in step S200. Alternatively or additionally, a query comprising audio-visual input may also be pre-processed using digital signal processing techniques and convolutional neural networks to identify its content prior to being provided with the query in step S200.

A query comprising an image component may be subject to pre-processing using a convolutional neural network to identify the content within the image. Data corresponding to the identified image content may then be included with the query in step S200.

The definition of contemporaneity used by the LLM 104 or the response generation module 102 may be changed by either an operative of the response generation module 102 or the user. For example, the user may change the definition so that contemporaneity is only answered in the positive, i.e. with a yes, if the data was last up to date at a point in time which is earlier than what is provided by the LLM 104. If it becomes clear that the training of the LLM is now more up to date, then the operative may change contemporaneity to reference a new date.

The contemporaneous content which is obtained using the search engine API may also be subject to further processing by the response generation module 102. The content obtained using the search engine API may be subject to processing to determine whether it contains a contemporaneous component. For example, in the content which is submitted in step S212 above, i.e. the contemporaneous content relating to the monarch in the UK, a determination may be made as to whether the “died in September 2022” is indeed contemporaneous itself. Evidently, in the example of ChatGPT which is only up to date as of September 2021, this would be contemporaneous as it is possible it has changed. If the temperature setting used by the user of client device 100 or the operative of response generation module 102 has been set for more creative output, i.e. between 0.5 and 0.7, this may be used as the basis for resubmitting a prompt with new information and then restarting the steps S210 to S216 to provide an amended response which is perhaps more creative and reflective, including, perhaps some of the rumoured causes of the death of Queen Elizabeth II.

The responses provided in either of steps S216 or S222 or step S228 may be subject to validation and verification checks by the response generation module 102 and a message may be attached to the response which contains a message regarding the likely truth in the response.

Such validation may be provided by the response generation module 102 to determine consistency in the response. For example, in the above example relating to the monarch in the UK, a validation check may perform a search of the internet using the API module 106 to determine whether there is a recorded death of Queen Elizabeth II. The search query may be built using natural language processing and submitted to a search engine API. Such a consistency check may lead to a validation check which says the response is 95% likely to be true.

The temperature settings employed by the user may also determine the content of a validation message. For instance, if the user uses temperature setting of 0, i.e. zero, the responses they get will be very factual and lack any kind of “creative” output from the LLM 104. The validation message in this instance may say that the response is likely to be true. Alternatively, if the user uses temperature settings of 0.6, more creative and subjective output is provided in the response and a validation message may say that the response may contain components which are false or not fact-based.

Other data validation techniques may be employed.

The response generation module 102 may also deploy verification techniques based on trusted sources of information. News sources may be categorised and given a weighting, for instance. For example, social media outlets may be given a weighting of 0.3 and established news outlets such as, for example, the BBC, may be given a higher weighting of 0.7. These weightings may be used to produce a rating which characterises the likelihood of truth in the output.

Other data verification techniques may be employed.

The responses which are obtained by the response generation module 102 and provided to the client device 100 may be associated with a user profile and stored in association with the user profile. The associated user details may be anonymised.

It should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as whole. In the present specification, “comprises” means “includes or consists of” and “comprising” means “including or consisting of”. The singular reference of an element does not exclude the plural reference of such elements and vice-versa. The invention may be implemented by means of hardware comprising several distinct elements, and by means of a suitable programmed computer. In a device claim enumerating several means, several these means may be embodied by one and the same item of hardware. The mere fact that certain measures are recited in mutually different dependent claims does not indicate that a combination of these measures cannot be used to advantage.

1. A computer-implemented method of providing a response to a query from a client device, the method implemented by a processing resource, the method comprising:
providing a platform configured to receive a query from a client device;
receiving the query from a client device via a user interface;
processing the query to generate a prompt for a large language model;
determining, using the prompt, whether the query relates to contemporaneous data; and
based on the determination, providing a response including a contemporaneous component.

2. A method according to claim 1, wherein providing a response including a contemporaneous component comprises:
if the query relates to contemporaneous data, determining whether the large language model is configured to provide a contemporaneous component;
and if the large language model is configured to provide a contemporaneous component, providing a response based on output from the large language model, wherein the response comprises the contemporaneous component; and
if the large language model is not configured to provide a contemporaneous component, obtaining the contemporaneous component and providing a response including the obtained contemporaneous component.

3. A method according to claim 1, wherein processing the query to generate a prompt for a large language model comprises an application of natural language processing or machine learning techniques to determine the prompt for the large language model.

4. A method according to claim 1, wherein the determination whether the query relates to contemporaneous data comprises providing a prompt to a large language model.

5. A method according to claim 4 wherein providing the prompt utilises a zero-temperature request to the large language model.

6. A method according to claim 1, wherein the determination whether the query relates to contemporaneous data comprises providing the query to a trained model.

7. A method according to claim 6 wherein the trained model is trained to determine a presence of terms which identify contemporaneity in the query.

8. A method according to claim 2, wherein providing the response including the contemporaneous component comprises:
updating the large language model to include the contemporaneous component; and
obtaining a response from the large language model including the contemporaneous component.

9. A method according to claim 8, wherein the method further comprises obtaining a further response component and determining whether the further response component comprises further contemporaneous components.

10. A method according to claim 1, wherein, prior to providing the response including the contemporaneous component, a validation process is applied to the response.

11. A method according to claim 10, wherein the validation process is based on a temperature setting in the large language model.

12. A method according to claim 1, wherein the query comprises an image.

13. A method according to claim 12, wherein the query is pre-processed to extract content from the image.

14. A method according to claim 13, wherein the pre-processing comprises an application of a convolutional neural network to the image.

15. A method according to claim 1, wherein the query comprises an audio component.

16. A method according to claim 15, wherein the query is pre-processed to extract content from the audio component.

17. A method according to claim 16 wherein the pre-processing comprises an application of digital signal processing techniques.

18. A method according to claim 1 wherein the prompt and query are re-processed to provide an updated response to the query.

19. A method according to claim 18, wherein the re-processing utilises a second large language model distinct from the large language model.

20. A system configured to implement the method of claim 1.

21. A non-transitory computer readable medium which comprises instructions which, when executed by a processing medium, configures the processing medium to implement the method of claim 1.

22. A computing device configured to implement the method of claim 1.
